(19) United States
(12) Patent Application Publication
(10) Pub. No.: US 2006/0184618 A1
(43) Pub. Date: Aug. 17, 2006

(54) Methods and systems for providing self-registration of communication services

(75) Inventors: Veenod Kurup, Alpharetta, GA (US); Scott A. Rogers, Roswell, GA (US); Sung Mok Yang, Alpharetta, GA (US)

Correspondence Address: MERCHANT & GOULD PC, P.O. BOX 2903, MINNEAPOLIS, MN, 55402-0903, US

(73) Assignee: Cox Communications, Inc.

(21) Appl. No.: 11/353,596

(22) Filed: Feb. 13, 2006

Related U.S. Application Data
(60) Provisional application No. 60/654,668, filed on Feb. 17, 2005.

(51) Int. Cl. G06F 15/16

(52) U.S. Cl. 709/203

(57) ABSTRACT

Systems and methods are disclosed for providing self-registration. The disclosed systems and methods may include receiving a request to connect a communications device to a network and determining that the communications device is unprovisioned. Furthermore, the disclosed systems and methods may include determining if the communications device is associated with a customer registered for service on the network based on user information received through the communications device. In addition, the disclosed systems and methods may include performing a communications device swap process if it was determined that the communications device is associated with the customer registered for service on the network. And the disclosed systems and methods may include performing a self-registration process if it was determined that the communications device is not associated with the customer registered for service on the network. Moreover, the disclosed systems and methods may include sending the communications device a reset command.

### RELATED APPLICATION

Under provisions of 35 U.S.C. § 119(e), Applicant claims the benefit of U.S. provisional application No. 60/654,668 entitled “Method And System for Self-Registration of Communication Services,” filed Feb. 17, 2005, which is incorporated herein by reference.

### BACKGROUND OF THE INVENTION

I. Field of the Invention

The present invention generally relates to methods and systems for providing self-registration. More particularly, the present invention relates to providing self-registration, for example, of communication services.

II. Background Information

A service provider may provide high speed Internet (HSI) service to a user using, for example, a broadband modem. Before the service provider can provide the HSI service to the user, however, the service provider may provision the broadband modem through a registration process. For example, the conventional registration process requires users to engage customer service representatives (CSRs) to register for and purchase, for example, HSI service. Additionally, CSRs are required to enter a HSI service work order into, for example, an integrated communications operations management system (ICOMS) in order to provide HSI service to the user. This often causes problems because the conventional strategy does not allow users to receive HSI service without engaging a CSR. For example, the conventional strategy does not allow users, for example, to receive HSI service utilizing self-registration via a web-based application or on compact disk (CD).

In view of the foregoing, there is a need for methods and systems for providing registration more optimally. Furthermore, there is a need for providing self-registration, for example, of communication services.

### SUMMARY OF THE INVENTION

Consistent with embodiments of the present invention, systems and methods are disclosed for providing self-registration.

In accordance with one embodiment, a method for providing self-registration comprises detecting a communications device on a network, determining that the communications device is unprovisioned, determining if the communications device is associated with a customer registered for service on the network based on user information received through the communications device, performing a communications device swap process if it was determined that the communications device is associated with the customer registered for service on the network, and performing a self-registration process if it was determined that the communications device is not associated with the customer registered for service on the network.

According to another embodiment, a system for providing self-registration comprises a memory storage for maintaining a database and a processing unit coupled to the memory storage, wherein the processing unit is operative to detect a communications device on a network, determine that the communications device is unprovisioned, determine if the communications device is associated with a customer registered for service on the network based on user information received through the communications device, perform a communications device swap process if it was determined that the communications device is associated with the customer registered for service on the network, and perform a self-registration process if it was determined that the communications device is not associated with the customer registered for service on the network.

In accordance with yet another embodiment, a computer-readable medium which stores a set of instructions which when executed performs a method for providing self-registration, the method executed by the set of instructions comprising detecting a communications device on a network, determining that the communications device is unprovisioned, determining if the communications device is associated with a customer registered for service on the network based on user information received through the communications device, performing a communications device swap process if it was determined that the communications device is associated with the customer registered for service on the network, and performing a self-registration process if it was determined that the communications device is not associated with the customer registered for service on the network.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary self-registration system consistent with an embodiment of the present invention;

FIG. 2 is a block diagram of an exemplary self-registration processor consistent with an embodiment of the present invention;

FIG. 3 is a flow chart of an exemplary method for providing self-registration consistent with an embodiment of the present invention;

FIG. 4 is a flow chart of an exemplary subroutine used in the exemplary method of FIG. 3 for sending the communications device a reset command consistent with an embodiment of the present invention; and

FIG. 5 is a diagram illustrating an exemplary operating environment consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Systems and methods consistent with embodiments of the present invention provide self-registration. This self-registration may allow users the ability to sign up, for example, for network (e.g. HSI) service or to swap out their current communications device (e.g. cable modem) for a new one, all without calling a CSR. Upon connecting an unprovisioned communications device to a network, for example, the user may be redirected to a “walled garden” with extremely limited connectivity. This walled garden may force the unprovisioned communications device user to interact with, for example, a web application in order to provision their unprovisioned communications device and gain unrestricted access to the network (e.g. the Internet.)

Once in the walled garden, the user may be prompted to enter user information sufficient for the system to identify an existing customer account. For example, the user information my be compared with customer account data held in a database to determine if the user associated with the user information is already a provisioned network customer.

If the user already exists as a provisioned network user, the system may assume that the user has replaced their old communications device with a new communications device (e.g. replaced an old cable modem with a new cable modem.) Specifically, the system may execute a communications device swap process, allowing the user to provision, for example, a new communications device. Communications device data on the new communications device, for example, may be gathered and stored by the system.

If the user does not already exists as a provisioned network user, the system may lead the user through a data gathering flow in order to provision a new account associated with the user and the currently connected communications device. Additional user information may be gathered from the user in order to, for example, set up billing, establish a user ID and email, and provision the currently connected communications device. Once this data gathering flow has been successfully completed, the currently connected communications device may be reset (e.g. rebooted) and the user may be granted unrestricted access to the network (i.e. no longer limited to the wall garden.)

An embodiment consistent with the invention may comprise a system for providing self-registration. The system may comprise a memory storage for maintaining a database and a processing unit coupled to the memory storage. The processing unit may be operative to detect a communications device on a network and to determine that the communications device is unprovisioned. Furthermore, the processing unit may be operative to determine if the communications device is associated with a customer registered for service on the network based on user information received through the communications device. In addition, the processing unit may be operative to perform a communications device swap process if it was determined that the communications device is associated with the customer registered for service on the network. Also, the processing unit may be operative to perform a self-registration process if it was determined that the communications device is not associated with the customer registered for service on the network.

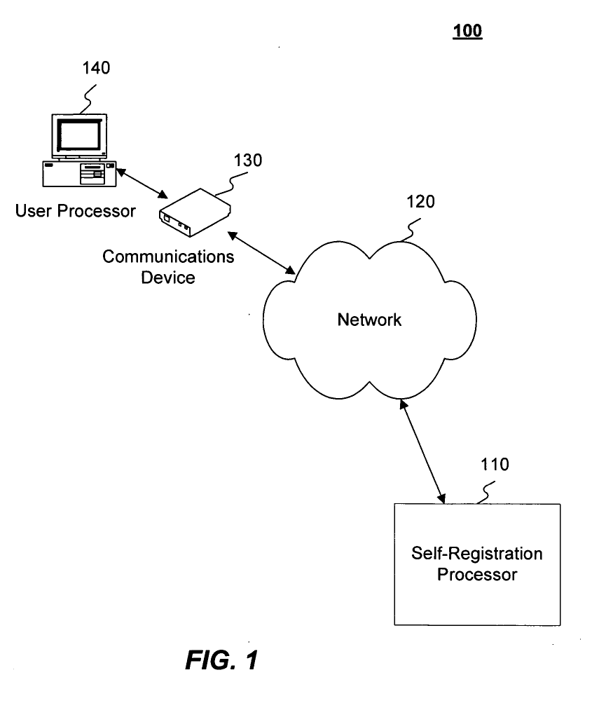

Consistent with an embodiment of the present invention, the aforementioned memory, processing unit, and other components may be implemented in a self-registration system, such as an exemplary self-registration system 100 of FIG. 1. Any suitable combination of hardware, software and/or firmware may be used to implement the memory, processing unit, or other components. By way of example, the memory, processing unit, or other components may be implemented with any of a self-registration processor 110 or other processors (not shown), in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which the features and principles of the present invention may be implemented. As illustrated in the block diagram of FIG. 1, system 100 may include self-registration processor 110, a network 120, a communications device 130, and a user processor 140. Communications device 130 may comprise, but is not limited to, a cable modem. Furthermore, communications device 130 may comprise any device capable of allowing user processor 140 to communicate with network 120.

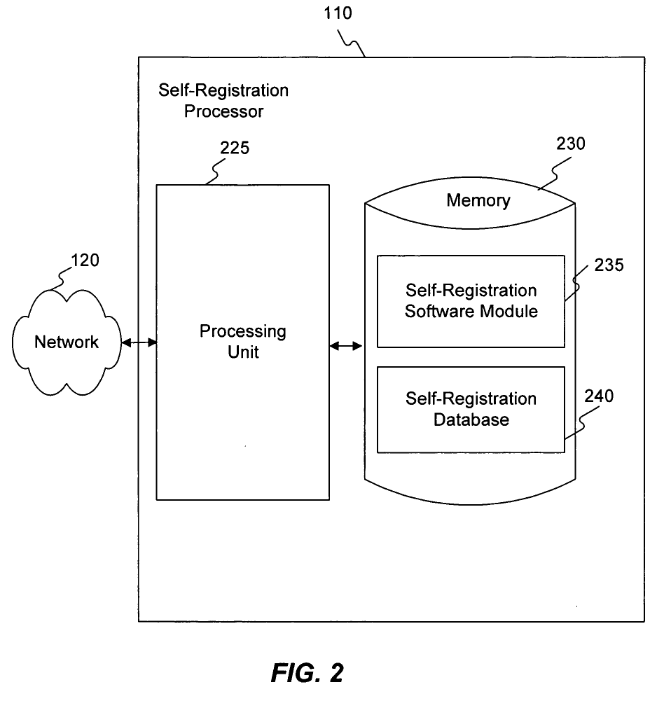

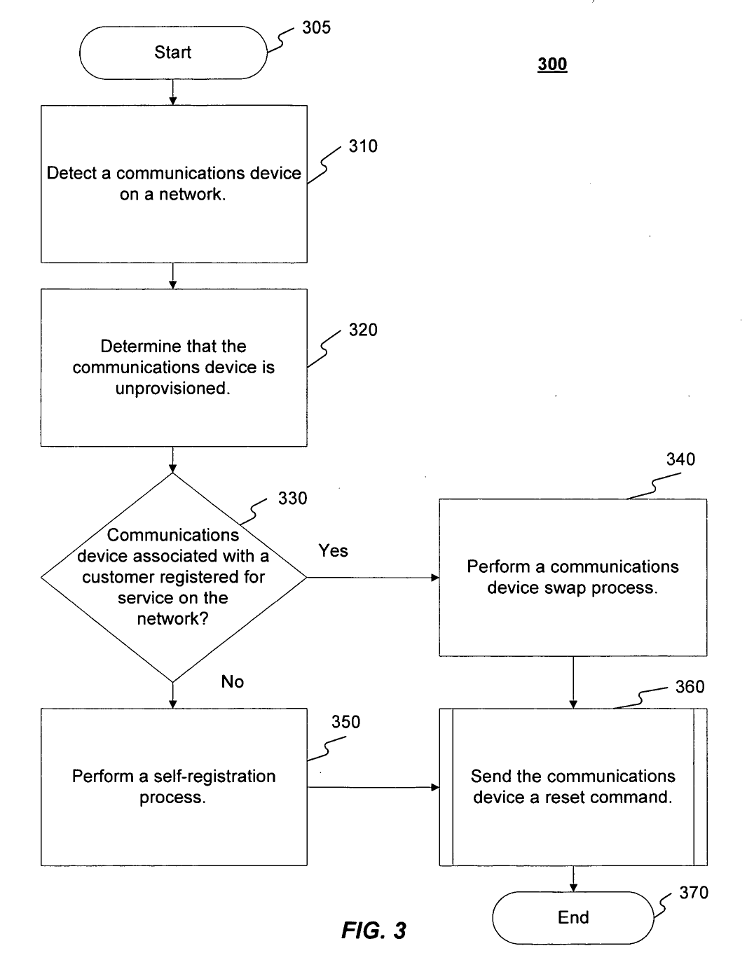

FIG. 2 shows self-registration processor 110 of FIG. 1 in more detail. As shown in FIG. 2, self-registration processor 110 may include a processing unit 225 and a memory 230. Memory 230 may include a self-registration software module 235 and a self-registration database 240. While executing on processing unit 225, self-registration software module 235 may perform processes for providing self-registration, including, for example, one or more of the stages of method 300 described below with respect to FIG. 3. Furthermore, any combination of the functionality of software module 235 and database 240 may be executed on or reside in one or more other processor (not shown) alone or in combination with self-registration processor 110 as shown in FIG. 1.

Self-registration 110 or user processor 140 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

Network 120 may comprise, for example, a local area network (LAN) or a wide area network (WAN). Such networking environments are commonplace in offices, enterprise-wide computer networks, intranets, and the Internet. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

System 100 may also transmit data by methods and processes other than, or in combination with, network 120. These methods and processes may include, but are not limited to, transferring data via, diskette, flash memory sticks, CD ROM, facsimile, conventional mail, an interactive voice response system (IVR), or via voice over a publicly switched telephone network.

FIG. 3 is a flow chart setting forth the general stages involved in an exemplary method 300 consistent with the invention for providing self-registration using system 100 of FIG. 1. Exemplary ways to implement the stages of exemplary method 300 will be described in greater detail below. Exemplary method 300 may begin at starting block 305 and proceed to stage 310 where self-registration processor 110 may detect communications device 130 on network 120. For example, when the user causes communications device 130 to connect to network 120, self-registration processor 110 may ping communications device 130 over network 120 for communications device 130's communications device data. The communications device data may comprise one or more of communications device 130's: i) media access control (MAC) address; ii) serial number; and iii) item number. The aforementioned are exemplary, and other elements may be used to identify communications device 130. A MAC address is a unique serial number burned, for example, into Ethernet and Token Ring network cards that identifies a particular network card from others.

From stage 310, where self-registration processor detects communications device 130 on network 120, exemplary method 300 may advance to stage 320 where self-registration processor 110 may determine that communications device 130 is unprovisioned. For example, self-registration processor 110 may query self-registration database 240 with communications device 130's communications device data to determine if communications device 130 is one that is provisioned to operate on system 100.

Moreover, self-registration processor 110 may look up communications device 130 in an inventory according to its communications device data and return communications device 130's information. Based on this information, self-registration processor 110 may use this information to make a determination as to whether communications device 130 is suitable for use on the user's account. For example, the following rules may be applied when determining the qualification of communications device 130's use:

1) If the detected communications device data is found more than once in the database, an error code may be returned to indicate this problem.

2) If communications device 130's communications device data is not found, communications device 130 may be considered a retail modem and the communications device data may be used.

3) If communications device 130's MAC address is not found and the serial number is found, communications device 130 may not qualify and an error code may be returned.

4) If a communications device 130's MAC address is found and is already assigned to the account attempting to qualify, the modem qualifies and the serial number and item number found may be used.

5) If communications device 130's MAC address is found and is assigned to a subscriber other than the one attempting to qualify (i.e. the user), the following logic may apply:
a) If communications device 130's has an item number that starts with ‘D’, for example, (e.g. service provider purchased), communications device 130 may not qualify and an error code will be returned.
b) If communications device 130 is a retail modem, for example, the provisioned status of communications device 130 may be checked. If the communications device 130 is not active (provisioned), it may be returned from the other account. Communications device 130 may now qualify and the serial number and item number found may be returned. If communications device 130 is active on another user's account, communications device 130 may not be modified and an error code may be returned.

6) If communications device 130's MAC address is found and is not assigned to a user, the following logic may apply:
a) If communications device 130 is in a status of “1” (e.g. in inventory), communications device 130 may not qualify and an error code may be returned.
b) If communications device 130 is in a status of “7” (e.g. assigned to tech/Installer), communications device 130 may qualify and the serial number and item number found may be returned.
c) If communications device 130 is in a status of “N” (e.g. non-inv tracking not at customer), communications device 130 may qualify and the serial number and item number found may be returned.
d) If communications device 130 is in a status of “T” (e.g. tech status), communications device 130 may not qualify and an error code may be returned.

Once self-registration processor 110 determines that communications device 130 is unprovisioned in stage 320, exemplary method 300 may continue to decision block 330 where self-registration processor 110 may determine if communications device 130 is associated with a user registered for service on network 120. For example, self-registration processor 110 may make this determination based on the user information received through communications device 130. Upon connecting an unprovisioned communications device to network 120, for example, the user may be redirected to a “walled garden” with limited connectivity. This walled garden may force the unprovisioned communications device user to interact with, for example, a web application in order to provision communications device 130 and gain, for example, unrestricted access to network 120.

Once in the walled garden, the user may be prompted to enter user information sufficient for the system to identify an existing user account. For example, the user information my be compared with customer account data held in database 240 to determine if the user associated with the information is already a provisioned network 120 user.

From decision block 330, if self-registration processor 110 determines communications device 130 is associated with a user registered for service on network 120, exemplary method 300 proceeds to stage 340 where self-registration processor 110 may perform a communications device swap process. For example, If the user already exists as a provisioned network 120 customer, self-registration processor 110 may assume that the user has replaced an old communications device with communications device 130 (e.g. replaced an old cable modem with a new cable modem.) Specifically, self-registration processor 110 may execute a communications device swap process, allowing the user to provision, for example, communications device 130. Communications device data on communications device 130, for example, may be gathered and stored by self-registration processor 110.

However, from decision block 330, if self-registration processor 110 determines that communications device 130 is not associated with the user registered for service on network 120, exemplary method 300 proceeds to stage 350 where self-registration processor 110 may perform a self-registration process. For example, if the user does not already exists as a provisioned network 120 user, self-registration processor 110 may lead the user through a data gathering flow in order to provision a new account associated with the user and currently connected communications device 130. Additional user information may be gathered from the user in order to, for example, set up billing, establish a user ID and email, and provision currently connected communications device 130. Once this data gathering flow has been successfully completed, currently connected communications device 130 may be reset (i.e. rebooted) and the user may be granted unrestricted access to network 120 (i.e. no longer limited to the wall garden.)

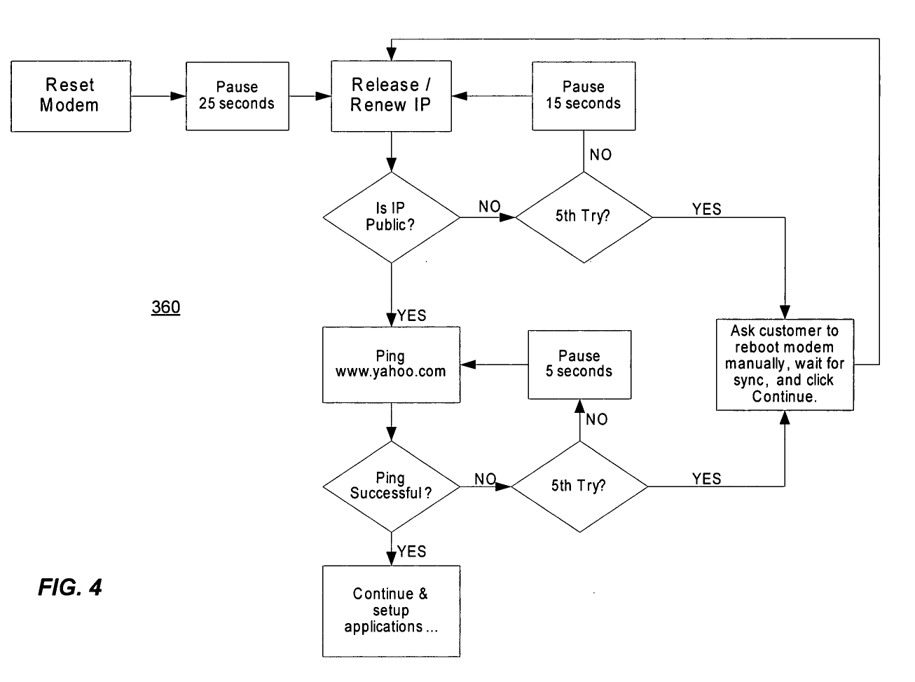

After self-registration processor 110 performs a communications device swap process in stage 340, or once self-registration processor 110 performs a self-registration process in stage 350, exemplary method 300 may proceed to exemplary subroutine 360 where self-registration processor 110 may send communications device 130 a reset command. The stages of exemplary subroutine 360 are described in greater detail below with respect to FIG. 4. After self-registration processor 110 sends communications device 130 the reset command in exemplary subroutine 360, exemplary method 300 may then end at stage 370.

FIG. 4 describes exemplary subroutine 360 from FIG. 3 for sending communications device 130 the reset command. For example, at the end of each process, communications device 130 may be reset in order to receive configuration information. User processor 140's IP address may also be released and renewed successfully for the user to complete the remainder of the flow and to have unrestricted access to network 120.

The process by which this is accomplished may automatically be modified to better handle exception scenarios. These modifications may be designed to avoid an error message being displayed to the user during this process. The modifications may also help ensure that all users will complete the remaining stages in the setup process. Once an IP address has been received associated with user processor 140, self-registration processor 110 may perform a connectivity check by pinging a public web site. If a new IP is not received or if the ping test has not completed successfully within the allotted number of retries, a message may be displayed with instructions for the user to reset communications device 130 manually, wait for communications device 130 to come online, and click a button to continue. After the button is clicked, the IP renewal and ping test may be attempted again and the cycle may be repeated until successful, at which time the flow may continue as normal.

Consistent with an embodiment of the present invention, an abuse screen may be presented to the user. For example, users who are suspended due to abuse may come to the self registration process if their communications device is deprovisioned instead of being reprovisioned with a restricted configuration. When it is detected that the user was disconnected for this reason, a screen may be displayed indicating the status of their account and giving them any necessary information.

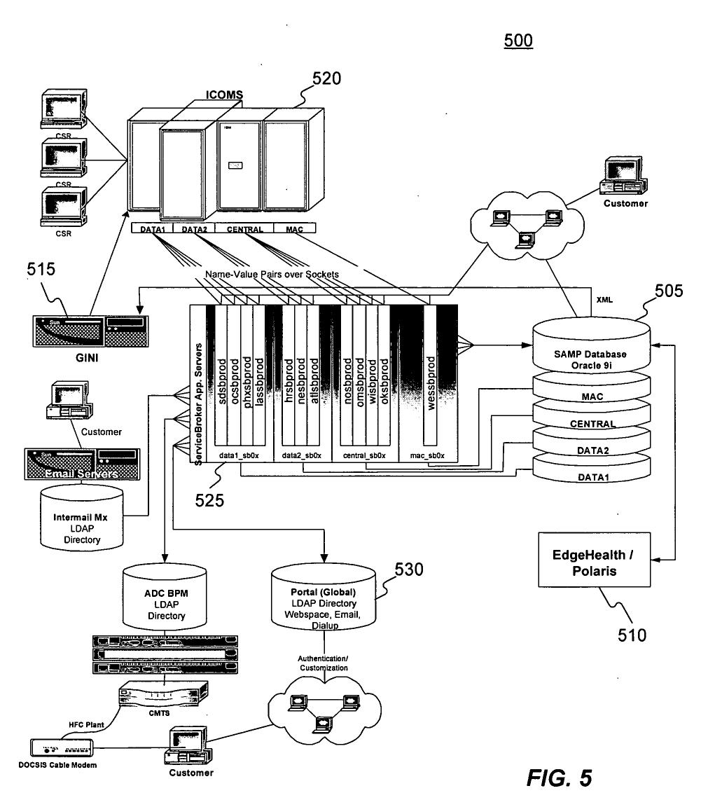

FIG. 5 illustrates an exemplary operating environment 500 consistent with an embodiment of the invention. For example, the self registration system may interface with a number of existing back-end systems in order to deliver the aforementioned provisioning functionality. Customer account data may be held in a SAMP 505 to determine if the user is already a provisioned network 120 user. Communications device information on the new equipment may be gathered using edgehealth polling system 510 and stored in SAMP 505 to update the user's records. User data may be gathered and passed to a GINI (Global ICOMS Network Interface) system 515 in order to, for example, set up billing, establish a user ID and email, and provision the communications device. The provisioning transaction for a new user may be driven out of an integrated communications operations management system (ICOMS) 520.

Billing information may be gathered from a self registration web flow, passed to GINI 515, and stored in ICOMS 520. The user may select a high speed tier from those offered by the service provider. The user's desired ID/email address may be passed to a service broker application 525 and validated against the IDs stored in a global LDAP system 530 in order to prevent duplication of an ID/email address. Once the user has selected a unique ID, the provisioning transaction completes, gathering the user's communications device information with edgehealth system 510 and storing it in SAMP 505.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing self-registration, the method comprising:
detecting a communications device on a network;
determining that the communications device is unprovisioned;
determining if the communications device is associated with a customer registered for service on the network based on user information received through the communications device;
performing a communications device swap process if it was determined that the communications device is associated with the customer registered for service on the network; and
performing a self-registration process if it was determined that the communications device is not associated with the customer registered for service on the network.

2. The method of claim 1, wherein detecting the communications device on the network further comprises detecting the communications device on the network comprising a broadband network.

3. The method of claim 1, wherein detecting the communications device on the network further comprises detecting the communications device comprising a cable modem.

4. The method of claim 1, wherein determining if the communications device is associated with the customer registered for service on the network further comprises:
directing the communications device to a walled garden;
querying a user for the user information through the communications device; and
comparing the user information to a customer database to determine if the communications device is associated with the customer registered for service on the network.

5. The method of claim 1, wherein performing the communications device swap process further comprises:
receiving communications device data associated with the communications device; and
storing the received communications device data in association with the customer registered for service on the network.

6. The method of claim 1, wherein performing the self-registration process further comprises:
querying a user for the user information through the communications device;
receiving communications device data associated with the communications device; and
storing the received communications device data in association with the user information.

7. The method of claim 1, further comprising sending the communications device a reset command.

8. A system for providing self-registration, the system comprising:
a memory storage for maintaining a database; and
a processing unit coupled to the memory storage, wherein the processing unit is operative to:
detect a communications device on a network;
determine that the communications device is unprovisioned;
determine if the communications device is associated with a customer registered for service on the network based on user information received through the communications device;
perform a communications device swap process if it was determined that the communications device is associated with the customer registered for service on the network; and
perform a self-registration process if it was determined that the communications device is not associated with the customer registered for service on the network.

9. The system of claim 8, wherein processing unit being operative to detect the communications device on the network further comprises the processing unit being operative to detect the communications device on the network comprising a broadband network.

10. The system of claim 8, wherein the processing unit being operative to detect the communications device on the network further comprises the processing unit being operative to detect the communications device comprising a cable modem.

11. The system of claim 8, wherein processing unit being operative to determine if the communications device is associated with the customer registered for service on the network further comprises the processing unit being operative to:
direct the communications device to a walled garden;
query a user for the user information through the communications device; and
compare the user information to a customer database to determine if the communications device is associated with the customer registered for service on the network.

12. The system of claim 8, wherein the processing unit being operative to perform the communications device swap process further comprises the processing unit being operative to:
receive communications device data associated with the communications device; and
store the received communications device data in association with the customer registered for service on the network.

13. The system of claim 8, wherein the processing unit being operative to perform the self-registration process further comprises the processing unit being operative to:
query a user for the user information through the communications device;
receive communications device data associated with the communications device; and
store the received communications device data in association with the user information.

14. The system of claim 8, further comprising the processing unit being operative to send the communications device a reset command.

15. A computer-readable medium which stores a set of instructions which when executed performs a method for providing self-registration, the method executed by the set of instructions comprising:
detecting a communications device on a network;
determining that the communications device is unprovisioned;
determining if the communications device is associated with a customer registered for service on the network based on user information received through the communications device;
performing a communications device swap process if it was determined that the communications device is associated with the customer registered for service on the network; and
performing a self-registration process if it was determined that the communications device is not associated with the customer registered for service on the network.

16. The computer-readable medium of claim 15, wherein detecting the communications device on the network further comprises detecting the communications device on the network comprising a broadband network.

17. The computer-readable medium of claim 15, wherein determining if the communications device is associated with the customer registered for service on the network further comprises:
directing the communications device to a walled garden;
querying a user for the user information through the communications device; and
comparing the user information to a customer database to determine if the communications device is associated with the customer registered for service on the network.

18. The computer-readable medium of claim 15, wherein performing the communications device swap process further comprises:
receiving communications device data associated with the communications device; and
storing the received communications device data in association with the customer registered for service on the network.

19. The computer-readable medium of claim 15, wherein performing the self-registration process further comprises:
querying a user for the user information through the communications device;
receiving communications device data associated with the communications device; and
storing the received communications device data in association with the user information.

20. The computer-readable medium of claim 15, further comprising sending the communications device a reset command.
